(19) United States
(12) Patent Application Publication
(10) Pub. No.: US 2002/0113669 A1
(43) Pub. Date: Aug. 22, 2002

(54) Small size cross-coupled trisection filter

(76) Inventor: Chin-Li Wang, Hsinchu (TW)

Correspondence Address: BIRCH STEWART KOLASCH & BIRCH, PO BOX 747, FALLS CHURCH, VA, 22040-0747, US

(21) Appl. No.: 09/883,987

(22) Filed: Jun. 20, 2001

(30) Foreign Application Priority Data
Feb. 22, 2001 (TW) 90104019

(51) Int. Cl. H01P 1/203

(52) U.S. Cl. 333/204; 333/219

(57) ABSTRACT

The present invention relates to a filtering structure, which minimizes bandpass filtering structure using a multilayer implementation, thus appearing at the attenuation poles on both sides of the bandpass, and the system demands are satisfied by adjusting the position of the attenuation poles in a cross-coupled form.

### BACKGROUND OF THE INVENTION

1. Field of the Invention

The present invention relates to a cross-coupled trisection filter, with inductance and capacitance devices, thereby reducing its physical size and increasing the production yield.

2. Description of Related Art

Filters are a common device in communication systems. Filters can regulate waveform, inhibit harmonic emission, and reduce system mirror noise. In a communications system, five filters or more are normal, depending on the operating requirements. Thus, filters can be very large. However, wireless personal communications require compact, light, and thin characteristics. The filter design is developed to a high bandwidth selectivity and small size.

According to the filter design specification, if the degree of the resonator is increased, the selectivity of the frequency band is increased. However, this is accompanied with bandpass attenuation and an increase in physical size. Refer to FIG. 1 for a prototype of a cascade trisection bandpass filter. As shown in FIG. 1, any cascade trisection bandpass filter generally provides asymmetric frequency response. Conventional bandpass filters with asymmetric frequency response are further described in “Microstrip Cross-coupled trisection bandpass filters with asymmetric frequency characters” by J.-S. Hong and M. J. Lancaster, as shown in FIG. 2a, and in “Microstrip Cascade Trisection Filter” by Chu-Chen Yang and Chin-Yang Chang, as shown in FIG. 2b. The resonators R1a, R2a, and R3a in FIG. 2a are construed on a substrate SUB, wherein the resonator R1a has an input port IN and the resonator R3a has an output port OUT. The resonators R1b, R2b, R3b, R4b, and R5b in FIG. 2b are construed on a substrate (not shown), wherein the resonator R5a has an input port P1 and the resonator R3a has an output port P2. As shown in FIG. 2a, the 3-pole filter structure is composed of three λ/2-line open-loop resonators R1a, R2a, R3a on one side of the dielectric substrate SUB with a ground plane on the other side. The cross coupling between resonators R1a and R3a exists because of their proximity. An attenuation pole of finite frequency exists on the high side of the pass band due to the cross-coupling. As shown in FIG. 2b, the 5-pole filter with two λ/2-line open-loop resonators and three hairpin resonators has mixed (electric and magnetic) couplings between resonators R1b and R2b and between resonators R2b and R3b, the mixed couplings between resonators R3b and R4b and between resonators R4b and R5b. The lower attenuation pole is due to the nonadjacent magnetic coupling between resonators R1b and R3b, and the upper attenuation pole is due to the nonadjacent electric coupling between resonators R3b and R5b. Thus, both FIGS. 2a and 2b can achieve a higher selectivity without increasing the degree of poles, i.e. the number of resonators. However, such a structure exhibits increased size and easily suffers spurious effect on odd frequencies of the band pass, so the required level of filtration is not achieved.

### SUMMARY OF THE INVENTION

Accordingly, an object of the invention is to provide a filtering structure, which adds a serial capacitance device into each resonator of the filter in FIG. 1 to reduce the filter size.

Another object of the invention is to provide a small size cross-coupled trisection filtering structure, which uses the semi-lumped LC resonator to avoid the spurious effect and also keep the attenuation pole on the high frequency during the band pass.

Another object of the invention is to provide a small size cross-coupled trisection filtering structure, which only couples to the high impedance transmission portion of the resonators, thereby fitting a multilayer and easily adjusting the frequency of an attenuation pole by changing the high impedance transmission distance of the first and third poles without changing the bandpass characteristics.

The invention provides a small size cross-coupled trisection filter structure, including a first resonance unit; a second resonance unit; and a third resonance unit. Each of the units includes an inductance device, e.g. a transmission line, and a capacitance device, e.g. a capacitor, wherein the high impedance transmission portions of two of the units are coplanar and one has an input while the other has an output.

### BRIEF DESCRIPTION OF THE DRAWINGS

The invention will become apparent by referring to the following detailed description of a preferred embodiment with reference to the accompanying drawings, wherein:

FIG. 1 is a prototype illustrating a cascade trisection bandpass filter;

FIG. 2a is a typical equivalent circuit of FIG. 1;

FIG. 2b is another typical equivalent circuit of FIG. 1;

FIG. 3 is an equivalent circuit of the invention;

FIG. 4 is an embodiment of FIG. 3 according to the invention;

FIG. 5 is another embodiment of the high impedance transmission portion of FIG. 3 according to the invention; and

FIG. 6 is another embodiment of the high impedance transmission portion of FIG. 3 according to the invention.

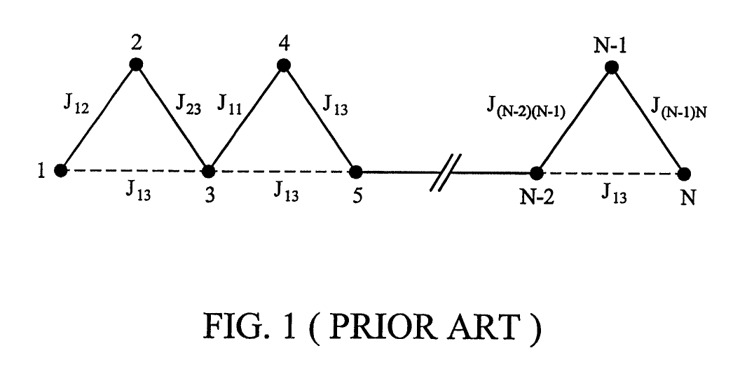

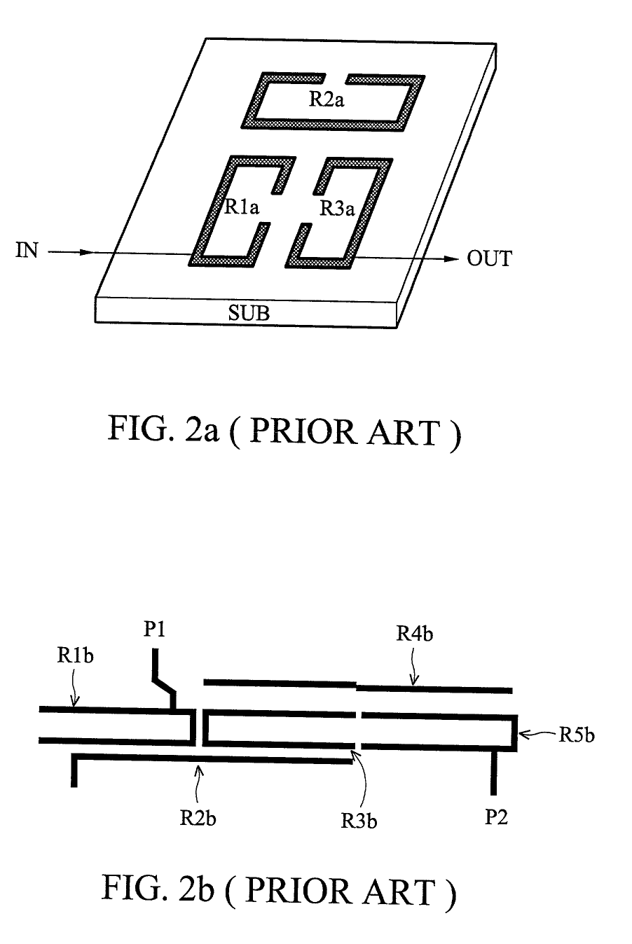

### DETAILED DESCRIPTION OF THE INVENTION

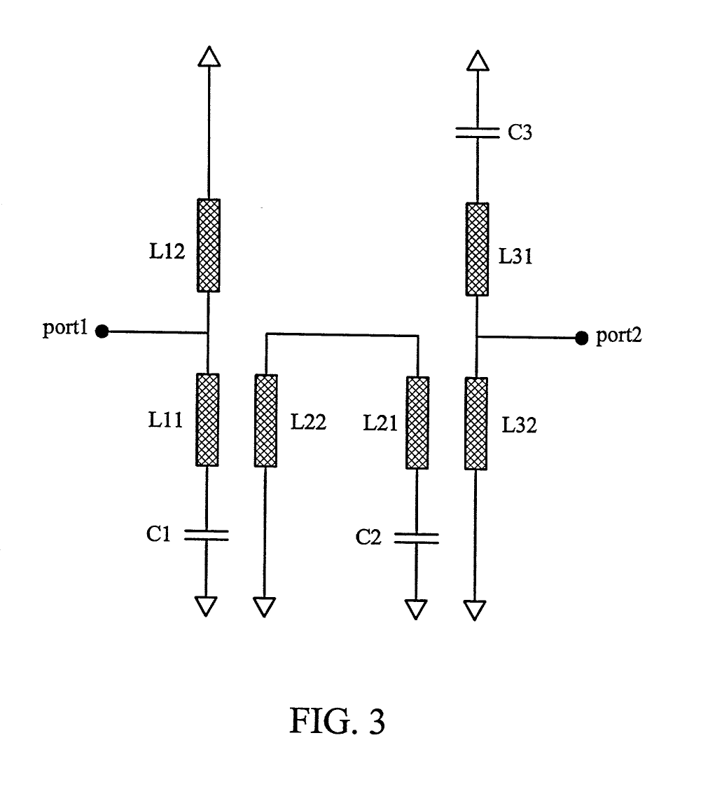

Refer to FIG. 3, an equivalent circuit of the invention, which is designed by using a semi-lumped LC resonator and according to a prototype of the cascade trisection (CT) bandpass filter structure. In FIG. 3, the circuit includes three resonance units, each having a high impedance transmission line and a serial capacitance device, wherein every high impedance transmission line can consist of two inductance devices.

As shown in FIG. 3, the equivalent circuit of a 3-pole bandpass filter is shown. In such an equivalent circuit, the high impedance transmission portion of the resonator is cross-coupled. A first trisection bandpass resonance unit includes high impedance transmission lines L11, L12 and a capacitance device C1. A second trisection bandpass resonance unit includes high impedance transmission lines L21, L22 and a capacitance device C2. A third trisection bandpass resonance unit includes high impedance transmission lines L31, L32 and a capacitance device C3. The coupling of lines L11 L22 and the coupling of lines L21, L32 are mainly coupled while the coupling of lines L11 L32 and the coupling of the first and third resonance units are cross-coupled. Also, capacitance devices C1, C2, C3 are the ground capacitance. The port Portl is located between lines L11 and L12, in order to input the signal to the circuit, the port Port2 is located between lines L31 and L32, in order to output the signal of the circuit.

[First Embodiment]

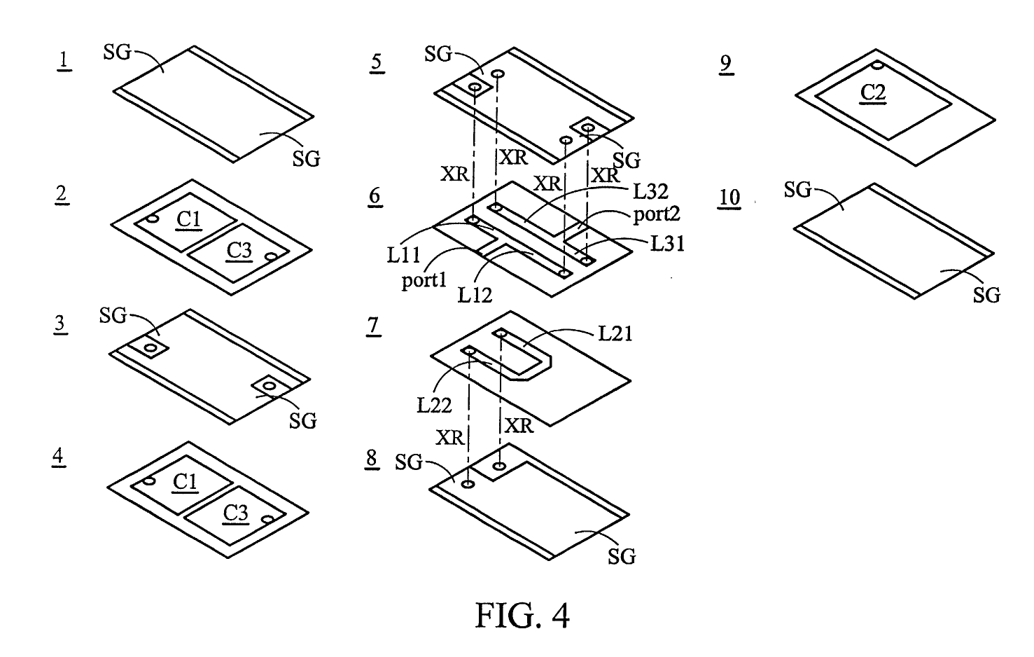

Refer to FIG. 4, an embodiment of FIG. 3. In FIG. 4, a low temperature cofire ceramic technique is carried to a filtering structure with a size 3.2 mm×2.5 mm×1.3 mm and having operating frequency 2.1 GHz, also its explored members included.

As shown in FIG. 4, the embodiment uses nine dielectric layers, which have thicknesses of 3.6, 3.6, 3.6, 3.6, 7.2, 11.8, 7.2, 3.6 and 3.6 (mil) respectively. The 1, 3, 5, 8 and 10 layers are a ceramic substrate SG with metal line, wherein the layers 1 and 10 are grounded, and the other layers use the edge grounding for isolation. The metal line can be silver, copper or any conductive material. The grounding capacitance mentioned above is carried by a metal-insulator-metal (MIM) structure in the embodiment. For example, the capacitance device C2 is an MIM structure forming of the metal layers 8, 9 and insulator layer therebetween (not shown) and the metal layers 9, 10 and insulator layer therebetween (not shown), as shown in FIG. 4. Moreover, the capacitance devices C1 and C3 of FIG. 3 are construed the same as the capacitance C2 of FIG. 4. A need to enlarge the capacitance values is created by increasing the number of layers. The coupling portion (inductance) of the high impedance transmission line mentioned above is achieved by conjoining the layers 5, 6. The main couplings of lines L11, L22 and lines L21, L32 are achieved by the non-coplanar coupling lines. The coupling value is decided by the requirement of bandwidth of the bandpass filter such that the coupling value is changed by the coupled overlap width or the dielectric thickness between the coupling lines. The couplings of lines L11, L12 and lines L31, L32 are carried by edge coupling of the coplanar coupling lines. Such a coupling value can adjust the frequencies of attenuation poles without changing the bandwidth and central frequency of the bandpass filter (see the appendix B, from the point A with 1.7 GHz shift to the point B with 1.45 GHz). Every line can be any conductive material, such as gold, copper, tin or others. The combination of every layer is achieved by vias, e.g. using lines XR through the corresponding vias between the layers, as shown in FIG. 4.

In a multilayer structure, the coupling line used in the embodiment has the advantages of small size and high yield.

[Second Embodiment]

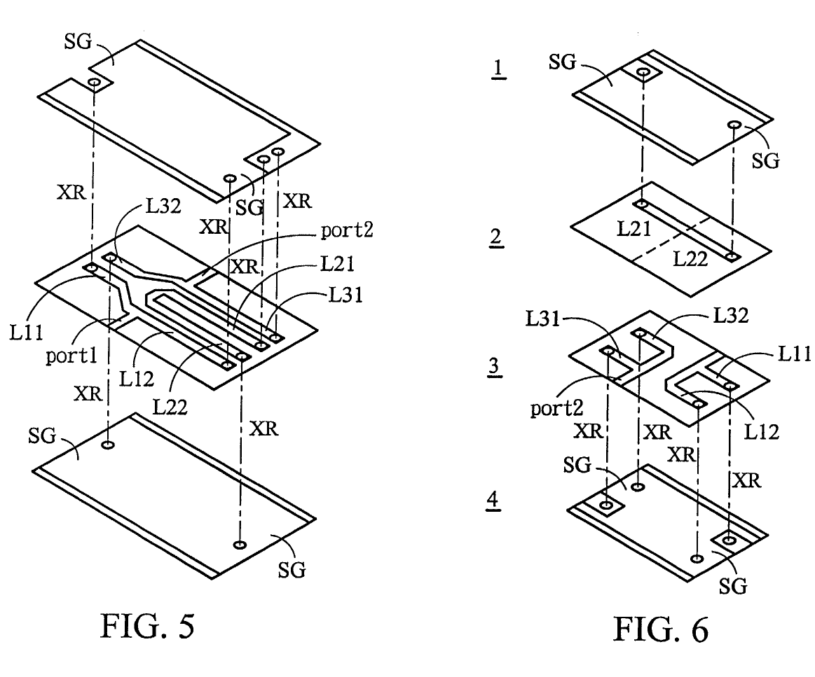

Refer to FIG. 5, further illustrating another embodiment of the high impedance transmission portion of FIG. 3. The implementation of the capacitance devices C1, C2, C3 of the embodiment is omitted because they are the same as the implementation of the capacitance of FIG. 4. The implementation of the high impedance transmission line follows.

As shown in FIG. 5, the high impedance transmission line is in the layout of an insulator-metal-insulator. The layers 1, 3 are a ceramic substrate with metal line, which use the edge grounding for isolation. The metal line can be silver, copper or any conductive material. The layer 2 is a line layer with the layout of the transmission degrees L1, L2, L3 inside. The difference from the first embodiment is all couplings using edge coupling of the coplanar coupling lines (not shown) in the embodiment, whether in the couplings between lines L11, L22 and lines L21, L32 or in the couplings between lines L11, L12 and lines L31, L32. Such a coupling value can adjust the frequencies of attenuation poles without changing the bandwidth and central frequency of the bandpass filter. Every line can be any conductive material, e.g. gold, copper, tin or others.

The advantage of the embodiment is its simple structure, which can be implemented by a two-face single board due to the coplanar layout of the capacitors.

[Third Embodiment]

Refer to FIG. 6, another embodiment of the high impedance transmission portion of FIG. 3. In FIG. 6, the implementation of the capacitance devices C1, C2, C3 of the embodiment is omitted because they are also the same as the implementation of the capacitance of FIG. 4. The implementation of the high impedance transmission line is described as follows.

As shown in FIG. 6, the layout is more similar to that of the first embodiment than the second embodiment. The difference from the first embodiment is the order of layout and the profile of the three-degree resonance transmission lines. The implementation is first performed by exchanging the layers 5, 8 of FIG. 3 into the layers 1, 4, respectively, of the embodiment. Then, the U-shaped layout of layer 7 in FIG. 3 is changed into the linear shape of layer 2 of the embodiment. Finally, the two T-shaped layouts of layer 7 in FIG. 3 are respectively changed into the two comb-like shapes of layer 3 in the embodiment. For the different layout order and shape of the transmission lines in the embodiment, the filtering structure created may have differently main-coupled and cross-coupled values from that of FIG. 3. However, the different values can be eliminated by the non-coplanar and coplanar coupling line adjustment. Accordingly, the embodiment can also adjust the frequencies of attenuation poles without changing the bandwidth and central frequency of the bandpass filter, as in the above embodiments.

Briefly, the resonator with the input port and the resonator with the output port have to implement in coplanar, and the metal layer and the insulator layer are interlaced in implementation. Therefore, various alterations and modifications in the circuit layout of the invention can be made.

Accordingly, the invention provides a small size cross-coupled trisection filtering structure, which minimizes bandpass filtering structure using a multilayer configuration, and adjusts the attenuation pole on both sides of the band pass to avoid the spurious effect appearing on odd frequencies of the bandpass (see appendix C, only one bandpass). Thus the filtering design will satisfy the specific demands.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

[image]

[image]

[image]

What is claimed is:

1. A small size cross-coupled trisection filtering structure, comprising:
a first resonance unit, having a first inductance device and a second inductance device connected to a first gounding capacitance device;
a second resonance unit, having a third inductance device, which produces the main coupling with the second inductance device, and a fourth inductance device connected to a second grounding capacitance device; and
a third resonance unit, having a fifth inductance device, which produces the main coupling with the fourth inductance device, and a sixth inductance device connected to a third grounding capacitance device.

2. The filtering structure of claim 1, further comprising a cross-coupling between the first and sixth inductance devices.

3. The filtering structure of claim 1, further comprising a cross-coupling between the first and third resonance units.

4. The filtering structure of claim 1, further comprising an input port positioned between the first and second inductance devices.

5. The filtering structure of claim 1, further comprising an output port positioned between the fifth and sixth inductance devices.

6. The filtering structure of claim 1, wherein the first and third resonance units are coplanar.

7. The filtering structure of claim 1, wherein all resonance units are coplanar.

8. A small size cross-coupled trisection filtering structure, comprising:
a first capacitance layer, having at least a first metal board with a first metal plane and a first layout board connected to the first metal plane, wherein the first metal board has a insulation edge to the ground and the first layout board has a capacitance device;
an inductance layer, having a pair of metal boards, one of the pair connected to the first layout board and a second layout board connected between the pair of metal boards, wherein each of the pair has an insulation edge to the ground and the second layout board has a predetermined inductance device; and
a second capacitance layer, having a third layout board connected to the other of the pair and a second metal board connected to the third layout board, wherein the second metal board has an insulation edge to the ground and the third layout board has a capacitance device.

9. The filtering structure of claim 8, wherein the predetermined inductance device is a 3-degree filtering structure.

10. The filtering structure of claim 9, wherein the 3-degree filtering structure further has a first filtering sub-structure with an input port, a second filtering sub-structure with an output port, and a third filtering sub-structure.

11. The filtering structure of claim 10, wherein the first and second filtering sub-structures are coplanar.

12. The filtering structure of claim 10, wherein all sub-structures are coplanar.

13. The filtering structure of claim 10, wherein the third filtering sub-structure is non-coplanar with other sub-structures.

14. The filtering structure of claim 10, wherein each sub-structure has an inductance device and a capacitance device.

15. The filtering structure of claim 14, wherein the serial value of the inductance device and the capacitance device is ranged on the passband.
